(19) United States
(12) Patent Application Publication
(10) Pub. No.: US 2019/0323927 A1
(43) Pub. Date: Oct. 24, 2019

(54) Tank Sampling System

(71) Applicant: RJ Maclean LP, Acheson (CA)

(72) Inventor: Greg MACLEAN, Fall River (CA)

(21) Appl. No.: 16/393,711

(22) Filed: Apr. 24, 2019

(30) Foreign Application Priority Data
Apr. 24, 2018 (CA) 3002467

(51) Int. Cl. G01N 1/08; G01N 1/10

(52) U.S. Cl. CPC G01N 1/08; G01N 1/10

(57) ABSTRACT

A tank sampling system for sampling through an opening in a tank below fluid level. The system includes a housing and a stinger moveable within the housing and through the opening. The stinger may seal against the housing to prevent fluid flow out of the tank. The stinger may comprise a tube and a plunger having a cap. The plunger may be extended relative to the tube to open the tube, and retracted to close it. The cap may be shaped to penetrate sludge and may seal against the housing when the stinger is retracted so as to prevent fluid flow from the tank as the tube is retracted to release the sample.

### TECHNICAL FIELD

Tank sampling.

### BACKGROUND

In order to obtain samples of sludge accumulating at the bottom of tanks, a sample tool is desired. Some current sample tools access the tanks from the top, and obtain a sludge sample by driving a tube into the sludge. However, for some tanks top access is not a convenient mode of access, particularly for floating roof tanks.

### SUMMARY

There is provided a sampling system for sampling contents of a tank through a tank opening disposed on the tank, the system having a stinger adapted to be inserted through the tank opening, the stinger comprising a tube defining a sample chamber having a chamber opening and a plunger slideably movable within a range of motion relative to the tube including a back position at which the plunger occludes the chamber opening and a forward position at which the plunger does not occlude the chamber opening, the system also having a housing arranged to be disposed on the tank opening, the housing comprising a restriction for slideably supporting and sealing against the stinger.

In various embodiments, there may be included any one or more of the following features: the housing may have a housing stop element and the stinger may have a corresponding stinger stop element to contact the housing stop element for restricting motion of the stinger away from the tank; the housing stop element may be a forward edge of the restriction; the plunger may comprise a rod and a cap attached to the rod, the cap contacting the tube to occlude the chamber opening when the plunger is in the back position; the cap may be the stinger stop element; the cap may be tapered; the housing may have a second restriction for slideably supporting the stinger; the first restriction and the second restriction may define a housing chamber; and there may be a drain valve connected to the housing chamber.

There is also provided a method of sampling contents of a tank through an opening, the method including the steps of providing a housing adapted to be connected to the opening, providing a stinger comprising a tube defining a sample chamber and a plunger, the stinger adapted to be inserted through the opening and to contact and seal against the housing, inserting the stinger through the opening, moving the plunger relative to the tube to open the sample chamber to obtain a sample, moving the plunger relative to the tube to close the sample chamber to retain the sample, and retracting the stinger through the opening.

In various embodiments, there may be included any one or more of the following features: the plunger may have a cap; the cap may contact the housing to seal the opening when the stinger is retracted; the step of moving the plunger relative to the tube to open the sample chamber may include extending the cap away from the tube, and the step of moving the plunger relative to the tube to close the sample chamber may include bringing the cap into contact with the tube; the cap may be tapered to penetrate sludge; the plunger may also be moved relative to the tube to release the sample into a housing chamber defined by the housing; an the sample may also be removed from the housing chamber via a valve connected to the housing chamber.

These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is a schematic diagram showing a floating roof tank with an opening for sampling;

FIG. 2 is a side cutaway view of a stinger for an embodiment of the sampling system shown in FIGS. 2-10, the stinger having a plunger in a back position;

FIG. 3 is a side cutaway view of the stinger of FIG. 2 with the plunger in a forward position;

FIG. 4 is a side cutaway view of a housing for the embodiment of the sampling system of FIGS. 2-10;

FIG. 5 is a side cutaway view of the embodiment of FIGS. 2-10 shown in an initial position;

FIG. 6 is a side cutaway view of the embodiment of FIGS. 2-10 shown in a position with the stinger inserted through the opening;

FIG. 7 is a side cutaway view of the embodiment of FIGS. 2-10 shown in a position with the stinger inserted and the plunger extended;

FIG. 8 is a side cutaway view of the embodiment of FIGS. 2-10 shown in a position with the stinger inserted through the opening and the plunger retracted to capture a sample;

FIG. 9 is a side cutaway view of the embodiment of FIGS. 2-10 shown in a position with the stinger retracted and containing a sample;

FIG. 10 is a is a side cutaway view of the embodiment of FIGS. 2-10 shown in a position with the stinger opened to deposit the sample into the housing; and

FIG. 11 is a is a side cutaway view of an embodiment with an extended stinger shown in a position corresponding to the position shown in FIG. 10 for the embodiment of FIGS. 2-10.

### DETAILED DESCRIPTION

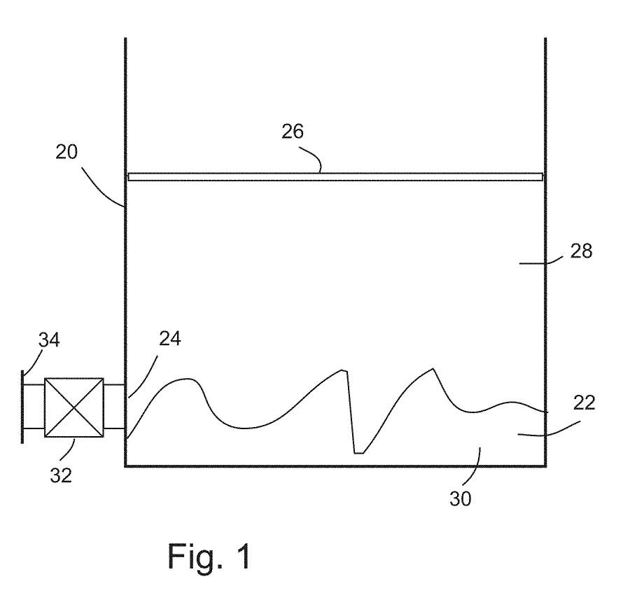

As shown schematically in FIG. 1, a tank 20 having tank contents 22 has an opening 24 located on a side of the tank for sampling. The opening could be located at any periphery of the tank including top or bottom, but in the example tank shown the opening 24 is located on a lower portion of a side wall of the tank 20. The system is primarily intended to sample through an opening below fluid level, but could also be extended from above fluid level into the tank contents. The tank shown in FIG. 1 has a floating roof 26 and has tank contents 22 including liquid 28 supporting the floating roof 26 and sludge 30 collecting at the bottom of the tank. “Sludge” here can mean any sort of material that collects at the bottom of a tank. The system described here could also be used for other tank types and for other tank contents. The opening 24 shown has a valve 32 and a flange 34. The valve 32 allows the sampling system described below to be attached and removed while the tank is full without leaking. FIG. 1 is a schematic figure only and is not to scale.

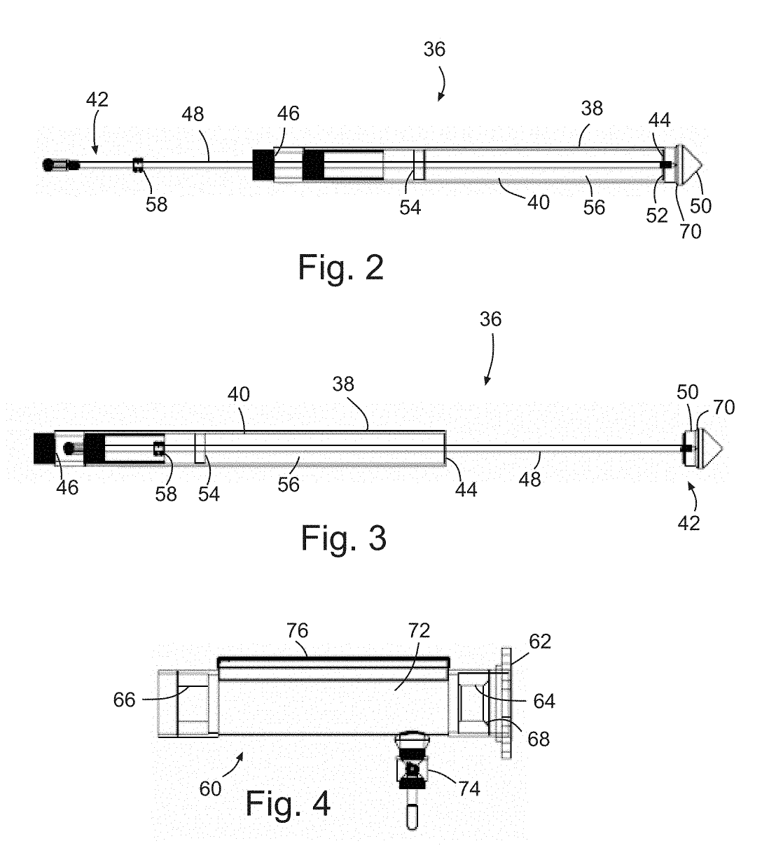

In order to sample the tank contents 22, a stinger 36 as shown in FIGS. 2 and 3 is provided for insertion into the tank 20 through the opening 24, and, if present, through valve 32. Stinger 36 comprises a tube 38 defining a bore 40, and a plunger 42. Bore 40 has a forward end 44 and a back end 46. Forward and back are defined here and throughout this document based on direction relative to the tank when the system is in use. Forward is towards or into the tank and back is away from or out of the tank. The plunger 42 comprises a rod 48 and a cap 50. The plunger 42 is moveable within the bore through a range of travel relative to the bore including a back position, as shown in FIG. 2, and a forward position, as shown in FIG. 3. When the plunger is in the back position as shown in FIG. 2, the cap 50 contacts the tube 38 to form a forward seal 52 of the bore 40. When the plunger is shown in the forward position as shown in FIG. 3, cap 50 no longer forms forward seal 52 of the bore 40; in the embodiment shown the cap is displaced away from tube 32 when the plunger 42 is in the forward position. A back seal of the bore 40 may be formed throughout the range of travel of the plunger by a sliding seal (not shown) between a restriction 54 of the bore 40 and the rod 48. The bore and back seal define a sampling chamber 56. The forward end 44 of the bore acts as an opening of the sample chamber. When the plunger is in the back position shown in FIG. 2, the cap 50 of the plunger 42 contacts the tube 38 and occludes the forward end 44 of the bore to close the sampling chamber 56. When the plunger 42 is in the forward position shown in FIG. 3, the plunger does not occlude the bore, causing the sample chamber 56 to be open. A stop 58 may be provided to limit the forward motion of the plunger within the bore. In the embodiment shown the backward motion of the plunger within the bore is limited by the contact of the cap 50 with the tube 38.

As shown in FIG. 4, a housing 60 may also be provided to support and align the stinger 36, to reduce leakage, and to capture fluids. In the embodiment shown, the housing 60 has a housing flange 62 which may be fastened to the corresponding flange 34, if present, associated with the opening 24 or valve 32. In the embodiment shown, the housing 60 has a first supporting portion 64 near the opening 24 and a second supporting portion 66 spaced from the opening 24. Each of the first supporting portion 64 and the second supporting portion 66 are sized and shaped to slideably accommodate at least a portion of the stinger 36. A stop portion 68 of the first supporting portion 64 may seal against a corresponding surface 70 of the cap 50 to help seal against any leaks through the opening 24 when the cap 50 is seated against the stop portion 68 of the first supporting portion 64. The first supporting portion 64 reduces leakage by reducing any gap between the stinger and the housing. Seals (not shown) may be provided on the first supporting portion to provide a sliding seal with the stinger to further minimize leakage. The second supporting portion 66 may likewise have seals (not shown). The first supporting portion 64 and the second supporting portion 66 define a housing chamber 72. In the event that fluid leaks through first supporting portion 64, the housing chamber 72 collects the leaked fluid. The housing chamber 72 also collects sampled contents as described below. The chamber 72 has a drain valve 74 for extracting leaked fluid and sampled contents from the chamber. The housing may further define a window 76 allowing observation and access to the housing chamber 72 from above.

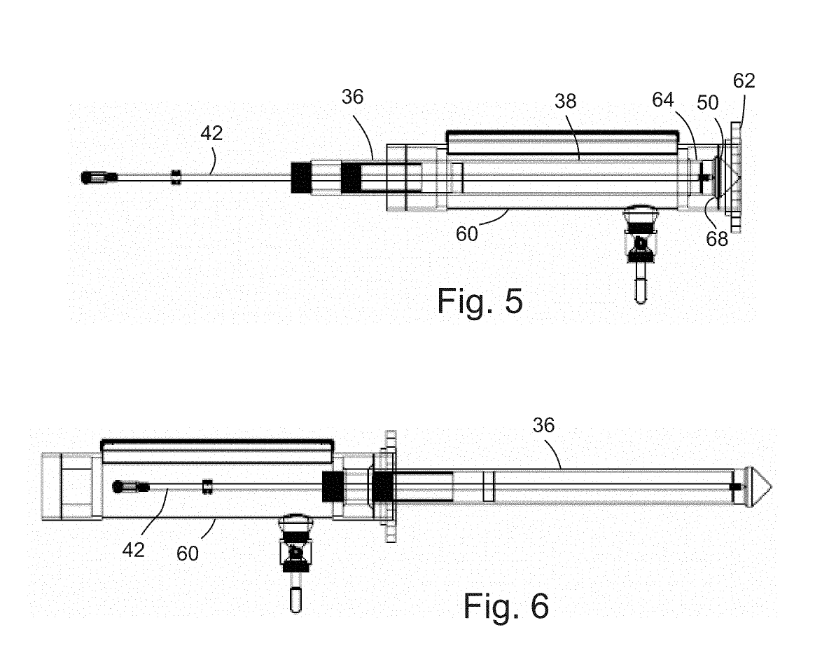

FIGS. 5-11 shows the operation of the sampling system in an embodiment to obtain a sample. FIGS. 5-11 show the sampling system only and do not show the tank 20, opening 24 or valve 32 or flange 34; these features can be seen schematically in FIG. 1. The sampling system may be attached to the tank 20 in an initial position shown for an embodiment in FIG. 5. This attachment may be accomplished for example by attaching the housing flange 62 to the flange 34 of the opening 24. In this embodiment, this position also serves as a default position of the sampling system between sampling operations. In this embodiment shown, the first and second supporting portions cannot accommodate the cap 50 of the stinger 36; the stop portion 68 of first supporting portion 64 acts as a stop preventing movement of the cap 50 back beyond the first supporting portion 64. This prevents the stinger 36 from being driven back out of the housing 60 under tank pressure. In other embodiments, another stop element than the stop portion 68 could be used as a housing stop element, and in further embodiments, another stop element than the cap 50 could be used as the stinger stop element. However, the use of the cap as the stinger stop element is convenient in that it allows the tube to be withdrawn while the cap is contacting the first supporting portion 64, in order to deposit the sampled tank contents in the housing chamber, as described below. In installing this embodiment the stinger 36 is inserted into the housing 60 from the forward end before the housing 60 is attached to the tank 20, as the cap cannot traverse the housing in this embodiment. In this embodiment, there is nothing preventing the stinger 36 from being pushed forward out of the housing and into the tank but the tank pressure. A stop (not shown) could be added to the stinger after the stinger 36 is inserted into the housing 60 to prevent this.

In the initial position shown in FIG. 5, the plunger 42 may be in a back position relative to the tube 38 of the stinger 36, in order to reduce the distance the rod 48 sticks out from the tank. The cap 50 may be in contact with the stop portion 68. If the opening has a valve, the valve may be opened while the system is in the position shown in FIG. 5. The tank pressure from the opening will press the cap against the stop portion. The first supporting portion 64 provides sealing against the tube 38 and the cap 50 may provide additional sealing against the stop portion 68.

From the initial position shown in FIG. 5, the stinger 36 is then inserted through the opening as shown in FIG. 6. The plunger 42 may remain in the back position as shown in FIG. 6. If the plunger were moved to the forward position before the stinger were inserted, then tank contents from immediately adjacent to the opening would enter the stinger. By keeping the plunger in the back position at this step, the proportion of sampled tank contents obtained from a further distance into the tank is increased.

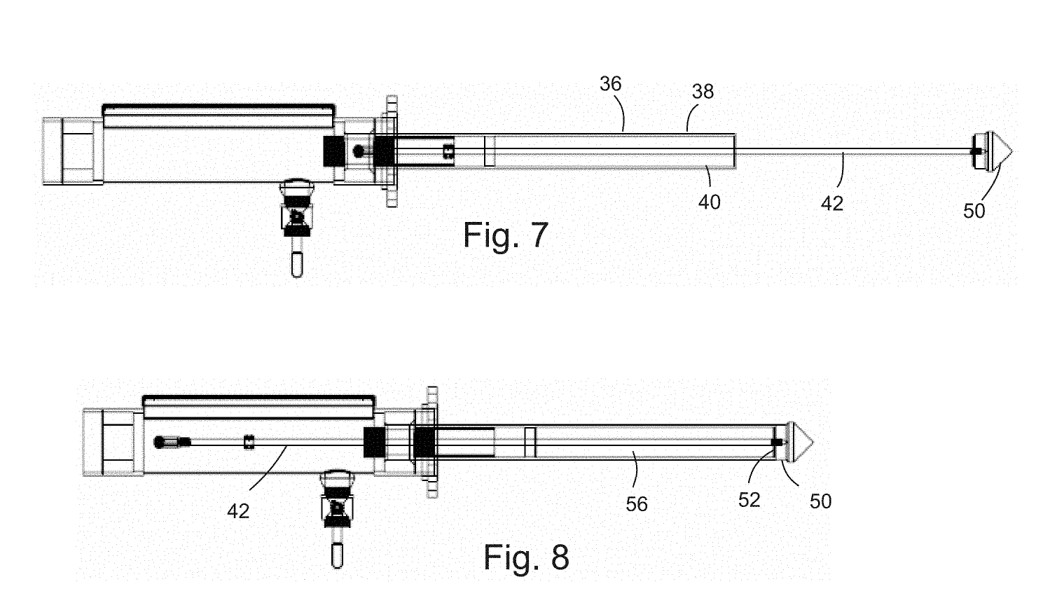

As shown in FIG. 7, once the stinger 36 is inserted through the opening, the plunger 42 is then moved to the forward position to open the bore 40 of the tube 38. Tank contents 22 will then move into the bore 40. The cap 50 may be tapered in the forward direction to aid penetration into sludge 30. As shown in FIG. 8, the plunger 42 is then returned to the back position to form a forward seal 52 of the bore 40 and define a sampling chamber 56 to contain the sampled tank contents. The positions of the system elements shown in FIG. 8 are the same in this embodiment as the positions shown in FIG. 6, but unlike in FIG. 6, tank contents are contained within the sampling chamber 56. As the plunger returns to the back position, the cap 50 may entrain sludge 30 which may be captured in sampling chamber 56.

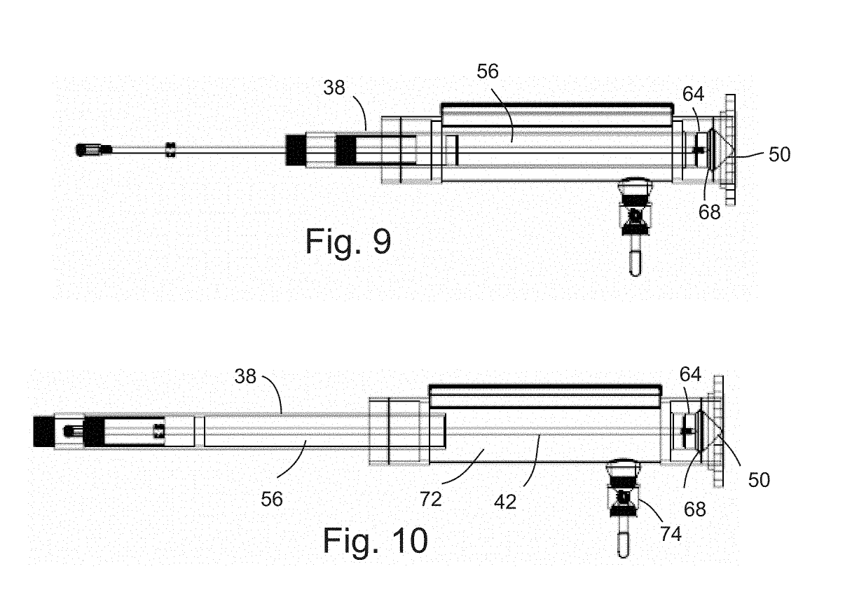

As shown in FIG. 9, the stinger 38 with a sample of tank contents 22 collected in sampling chamber 56 is withdrawn from the tank. The positions of the system elements shown in FIG. 9 are the same in this embodiment as the positions shown in FIG. 5, but unlike in FIG. 5 tank contents are contained within sampling chamber 56.

As shown in FIG. 10, the tube 38 is pulled back relative to plunger 42, to open up sampling chamber 56 and allow the sampled tank contents to flow from the sampling chamber 26 into the housing chamber 72. The tank contents can then be extracted from the housing chamber 72 using drain valve 74. After the tank contents have been removed from the sampling chamber, the tube 38 may be moved forward relative to plunger 42 to return the system to the initial configuration shown in FIG. 5. During the steps shown in FIG. 9 and FIG. 10, the cap 50 may remain in contact with the stop portion 68 and may maintain a seal against flow through the opening from the tank as tube 38 is withdrawn past the first supporting portion 64. If there is a valve 32 associated with the opening, the valve 32 may be closed at any time once the stinger 36 is sufficiently withdrawn from the tank to clear any moving parts of the valve 32 (for example while the system is in either of the configurations shown in FIGS. 9 and 10).

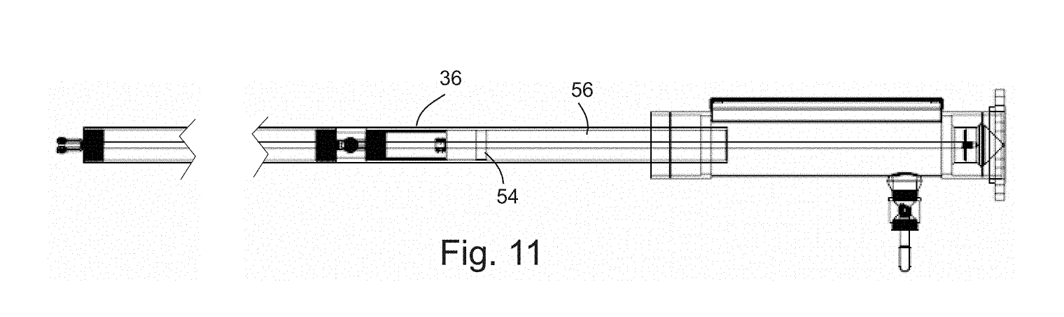

In order to extract samples from further distances within the tank, the stinger 36 may be made of greater length as shown in FIG. 1. The extended version shown in FIG. 11 is shown in the same stage of operation as shown in FIG. 10 for the regular version. The longer stinger may be inserted a greater distance into the tank. Restriction 54 may be placed so as to keep the size of the sampling chamber 56 similar to that shown in the embodiment of FIGS. 2-10.

Immaterial modifications may be made to the embodiments described here without departing from what is covered by the claims. In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A sampling system for sampling contents of a tank through a tank opening disposed on the tank, the system comprising:
a stinger adapted to be inserted through the tank opening, the stinger comprising a tube defining a sample chamber having a chamber opening and a plunger slideably movable within a range of motion relative to the tube including a back position at which the plunger occludes the chamber opening and a forward position at which the plunger does not occlude the chamber opening; and
a housing arranged to be disposed on the tank opening, the housing comprising a restriction for slideably supporting and sealing against the stinger.

2. The sampling system of claim 1 in which the housing has a housing stop element and the stinger has a corresponding stinger stop element to contact the housing stop element for restricting motion of the stinger away from the tank.

3. The sampling system of claim 2 in which housing stop element is a forward edge of the restriction.

4. The sampling system of claim 3 in which the cap is the stinger stop element.

5. The sampling system of claim 2 in which the plunger comprises a rod and a cap attached to the rod, the cap contacting the tube to occlude the chamber opening when the plunger is in the back position.

6. The sampling system of claim 5 in which the cap is tapered.

7. The sampling system of claim 5 in which the cap is the stinger stop element.

8. The sampling system of claim 5 in which the cap is tapered.

9. The sampling system of claim 1 in which the housing further comprises a second restriction for slideably supporting the stinger.

10. The sampling system of claim 9 in which the first restriction and the second restriction define a housing chamber.

11. The sampling system of claim 10 further comprising a drain valve connected to the housing chamber.

12. The sampling system of claim 1 in which the plunger comprises a rod and a cap attached to the rod, the cap contacting the tube to occlude the chamber opening when the plunger is in the back position.

13. The sampling system of claim 2 in which the housing further comprises a second restriction for slideably supporting the stinger.

14. A method of sampling contents of a tank through an opening, the method comprising the steps of:
providing a housing adapted to be connected to the opening;
providing a stinger comprising a tube defining a sample chamber and a plunger, the stinger adapted to be inserted through the opening and to contact and seal against the housing,
inserting the stinger through the opening;
moving the plunger relative to the tube to open the sample chamber to obtain a sample;
moving the plunger relative to the tube to close the sample chamber to retain the sample; and
retracting the stinger through the opening.

15. The method of claim 14 in which the plunger comprises a cap.

16. The method of claim 15 in which the cap contacts the housing to seal the opening when the stinger is retracted.

17. The method of claim 15 in which the step of moving the plunger relative to the tube to open the sample chamber comprises extending the cap away from the tube, and the step of moving the plunger relative to the tube to close the sample chamber comprises bringing the cap into contact with the tube.

18. The method of claim 15 in which the cap is tapered to penetrate sludge.

19. The method of claim 14 further comprising moving the plunger relative to the tube to release the sample into a housing chamber defined by the housing.

20. The method of claim 19 further comprising the step of removing the sample from the housing chamber via a valve connected to the housing chamber.
